(19) United States
(12) Patent Application Publication
(10) Pub. No.: US 2014/0074725 A1
(43) Pub. Date: Mar. 13, 2014

(54) FINANCIAL TRANSACTIONS WITH A VARYING PIN

(71) Applicant: Net1 UEPS Technologies, Inc., Johannesburg (ZA)

(72) Inventor: Serge Christian Pierre Belamant, Hurlingham (ZA)

(73) Assignee: Net1 UEPS Technologies, Inc., Johannesburg (ZA)

(21) Appl. No.: 14/018,265

(22) Filed: Sep. 4, 2013

Related U.S. Application Data
(60) Provisional application No. 61/696,726, filed on Sep. 4, 2012.

(51) Int. Cl. G06Q 20/40

(52) U.S. Cl. CPC G06Q 20/4012
USPC 705/72

(57) ABSTRACT

The present invention provides a financial transaction facilitating device for facilitating a financial transaction at an ATM, point of sale station, via the Internet or to login to a financial account by generating a PIN in response to a correct biometric identifier being supplied. Also provided are a financial transaction processing facility, a method of facilitating a financial transaction and a method of processing a financial transaction.

### REFERENCE TO RELATED APPLICATIONS

This application claims the benefit of U.S. provisional application Ser. No. 61/696,726, filed Sep. 4, 2012, which is herein incorporated by reference in its entirety.

### BACKGROUND OF THE INVENTION

This invention relates to electronic financial transactions. More particularly it relates to a financial transaction facilitating device, a financial institution processing facility, a method of facilitating a financial transaction and a method of processing a financial transaction.

For the last fifty years or so, financial institutions such as banks have issued plastic cards to their clients to perform financial transactions at Automatic Teller Machines (ATMs) and Point of Sale (POS) devices. More recently, Personal Identification Number (PIN) codes have been introduced to protect these cards from unauthorised usage. It is well known and documented in the industry that a number of problems arose from the introduction of PIN based systems.

The first problem is that PIN numbers must be somehow distributed or selected by the cardholder without being compromised. The second problem is that a comprehensive system must be put in place to allow for the changing of PINs either because the card holder wishes to do so or in the event that the initial PIN has been forgotten, locked or compromised.

These systems are on the one hand expensive but more importantly are often the focal attack point for fraudsters to compromise PINs in general.

The most problematic area however is PIN compromisation due to the increase in simple attacks such as viewing, cameras, electronic recording, skimming and the like to more sophisticated cryptographic analysis techniques.

This leads to fraud, losses and an increase in the systemic risk of national payment systems.

In less sophisticated environments, PIN usage is even more problematic as the user base is less educated and more likely to forget or/and simply hand over their PINs to nefarious individuals or criminal organizations.

Biometric verification resolves most of the above mentioned problems as clients have no secret PIN which can be compromised or used by anyone else. In addition, clients cannot lose something that is a part of them.

The challenge however is that biometric verification requires some form of an acceptance device to be built into the ATM or POS concerned. These biometric capturing devices are often expensive and require intensive software development and hardware integration. The result is that, many financial institutions, although in favour of biometric verification in principle do not support its implementation due to the cost of retrofitting their existing acquiring base. The net result is that clients continue to utilise PIN numbers, very often at their own risk as financial institutions warn them that their PIN must be securely stored to ensure that these are not compromised in any way.

This stance simply passes on the liability of an unsecure PIN based system to the card holders thus protecting the financial institutions against claims that exceed billions of US dollars every year.

### SUMMARY OF THE INVENTION

It is an object of the present invention to alleviate the deficiencies associated with static PINs and present biometric verification.

Thus, according to the invention there is provided a financial transaction facilitating device for facilitating a financial transaction, which includes an electronic processing device; a data storage unit; an input device operable by a transactor for inputting a request for a PIN; a biometric identifier input device for inputting a biometric identifier of the transactor; a verifying unit for verifying a biometric identifier provided, in use, by the transactor; a PIN generator for generating a PIN if the inputted biometric identifier is verified and an output device for supplying the PIN to the transactor.

Further according to the invention there is provided a method of facilitating a financial transaction which includes a transactor inputting a request for a PIN to an electronic device of the transactor; inputting a biometric identifier of the transactor; verifying the inputted biometric identifier; generating a PIN if the inputted biometric identifier is verified and supplying the PIN to the transactor.

It will be appreciated that the biometric identifier may be a sound signal, a visual signal or a fingerprint. If it is a sound signal, such as a voice message, the biometric identifier input device may include a microphone. If it is a visual signal, such as a representation of the transactor, the biometric identifier input device may include a camera. If it is a fingerprint then the biometric identifier input device may include a fingerprint scanner. If the biometric identifier is a voice message it may be a pass phrase or free speech.

The PIN generator may utilise a predetermined algorithm. The algorithm may be a cryptographic algorithm, using predetermined cryptographic keys. Further, a new PIN may be generated each time that a PIN is requested. Conveniently, the PINs may be generated in a sequential manner.

The output device may conveniently be a display.

Those skilled in the art will appreciate that it is desirable that the financial transaction facilitating device be operable in an off-line manner. Thus, the transactor's biometric identifier may be stored in the data storage unit and the inputted biometric identifier compared with the stored identifier and be verified if the two are sufficiently similar. It will further be appreciated that, for security reasons, an issuer of the credit or debit card will need to authenticate the stored biometric identifier. Thus, the transactor may authenticate his identity with the issuer and then be permitted to input his biometric identifier and store it, or the issuer may obtain the biometric identifier from the transactor once the transactor's identity has been authenticated, preferably in person, and then store it, or arrange for it to be stored, in the data storage unit. Thus, the financial transaction facilitating device may include a communication module whereby it may communicate with the financial institution.

The financial transaction facilitating device may be a mobile telephone, a tablet, a portable computer or a desktop computer.

Further according to the invention, there is provided a financial transaction processing facility of an issuer of credit or debit cards, which includes a receiving unit for receiving a transaction request from a transactor to whom a credit or debit card has been issued together with a PIN; a verifying unit for verifying the PIN; and a transaction approving unit for approving the transaction if the PIN is verified.

Still further according to the invention, there is provided a method of processing a financial transaction, which includes an issuer of a credit or debit card receiving a transaction request together with a PIN, from a transactor to whom the card has been issued; verifying the PIN; and approving the transaction if the PIN is verified.

As indicated above, the invention has particular application with biometrically verifiable credit and debit cards. Thus the financial transaction processing facility may include an identifying module for identifying that the transaction request is associated with a biometrically verifiable card and that the supplied PIN needs to be appropriately verified.

The received PIN may be verified by a check PIN being generated by the processing facility and this PIN being compared with the received PIN. Thus, the processing facility may include a check PIN generator and a comparator for comparing the two PINs. The check PIN generator may utilise a predetermined algorithm that is the same, or complementary to, the algorithm used by the financial transaction facilitating device. This algorithm may use cryptographic keys associated with the relevant account of the transactor.

Those skilled in the art will appreciate that such a varying PIN methodology may also be used when logging into an account with a financial institution via the Internet, and a varying PIN as supplied and contemplated by the invention may be used instead of a static PIN. Further, the varying PIN of the invention may be used instead of, or in addition to, so-called “second channel authentication” as occurs when a “One Time PIN” is sent via a different channel or an authenticating token is used. Accordingly, the phrases “a financial transaction facilitating device for facilitating a financial transaction” and “a method of facilitating a financial transaction” are to be understood as also incorporating logging into an account with a financial institution.

### BRIEF DESCRIPTION OF THE DRAWINGS

The invention will now be described by way of non-limiting examples, with reference to the accompanying diagrammatic drawings, in which:

FIG. 1 shows a financial transaction facilitating device in accordance with the invention; and

FIG. 2 shows a financial transaction processing facility in accordance with the invention.

### DETAILED DESCRIPTION OF THE INVENTION

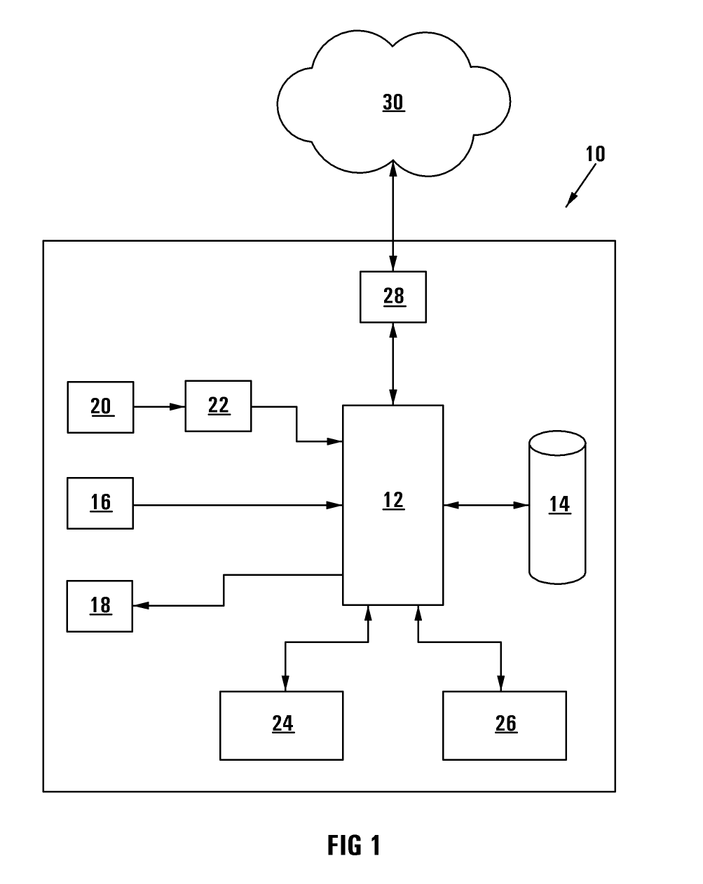

Referring to FIG. 1, a financial transaction facilitating device is referred to generally by reference numeral 10. The financial transaction facilitating device 10 comprises a mobile telephone that belongs to a client of a financial institution to whom a credit card has been issued. The financial transaction facilitating device 10 has a processor 12, a data storage unit 14, a keypad 16, a display 18, a microphone 20 with an analogue to digital convertor 22, a PIN generator 24, and a comparator 26. It further has an input/output interface 28 whereby it may connect to the Internet 30. The keypad 16 may be physical or virtual.

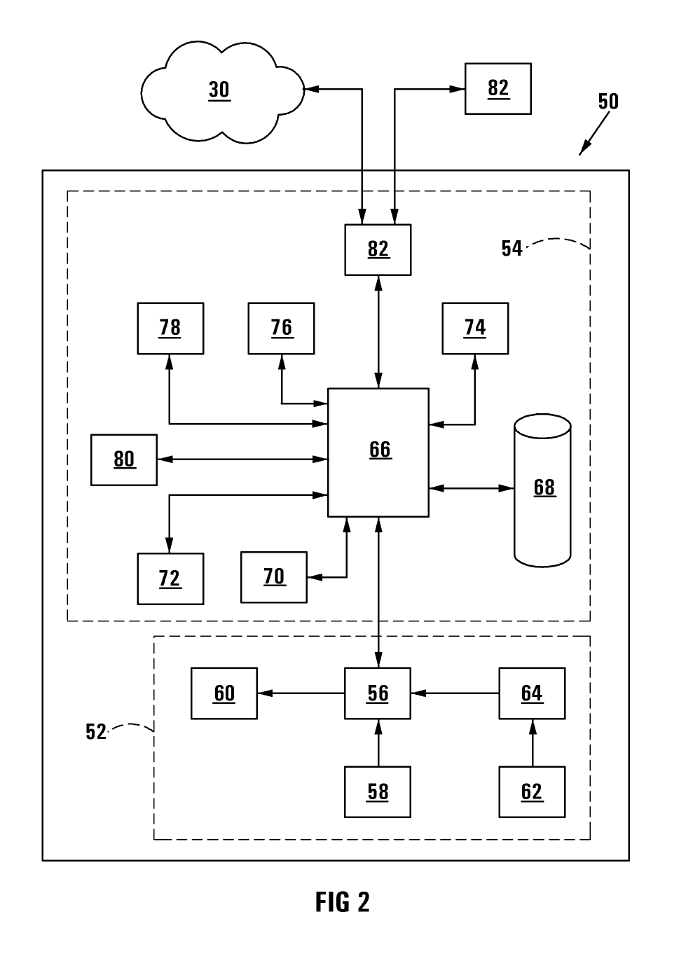

In use, a PIN generating application and an authenticated voice message are downloaded, via the Internet 30 from the financial transaction processing facility shown in FIG. 2 and stored in the data storage unit 14. The PIN generating application implements a predetermined algorithm with cryptographic keys, that are also securely stored in the data storage unit 14.

When the client wishes to perform a transaction requiring a PIN, he invokes the PIN generating application by means of the keypad 16. He is then required to provide the same voice message, which is captured by the microphone 20 and A/D convertor 22. This supplied biometric identifier is then compared, by the comparator 26 with the stored authenticated voice message. If they are sufficiently similar, the supplied voice message is verified and an appropriate signal supplied by the comparator 26 to the processor 12. The processor 12 then activates the PIN generator which generates a PIN that is supplied to the display 18, a new PIN being generated each time. The PIN is used by the client to perform his transaction by entering it at an ATM or POS device, to perform an Internet transaction or to log into an account with a financial institution. It will be appreciated that the financial transaction facilitating device 10 is operable offline.

An example of how the variable PIN is generated is illustrated below. This uses cryptographic keys and parameters stored in the data storage unit 14:

1. Create the variable PIN Clear Data block.

### CLEAR_DATA=(VPSN[2].VPP[1].USN[3].USERDATA[2])

2. Create variable PIN certificate (Diversified Keys).

### VP_CERT=3DES(CLEAR_DATA)

3. Increment sequence number.

VPSN=VPSN+1

4. Convert certificate decimal (ASCII numeric digits).

### DECIMALVP_CERT=CONVERT_TO_ASCIIDECIMAL(VP_CERT)

5. Extract PIN digits from the decimal certificate.

### PIN_DIGIT[0]=DECIMALVP_CERT[1]

### PIN_DIGIT[1]=DECIMALVP_CERT[3]

### PIN_DIGIT[2]=DECIMALVP_CERT[2]

### PIN_DIGIT[3]=DECIMALVP_CERT[5]

### PIN_DIGIT[4]=DECIMALVP_CERT[4]

### PIN_DIGIT[5]=DECIMALVP_CERT[7]

### PIN_DIGIT[6]=DECIMALVP_CERT[6]

### PIN_DIGIT[7]=DECIMALVP_CERT[9]

### PIN_DIGIT[8]=DECIMALVP_CERT[8]

### PIN_DIGIT[9]=DECIMALVP_CERT[11]

### PIN_DIGIT[10]=DECIMALVP_CERT[10]

### PIN_DIGIT[11]=DECIMALVP_CERT[13]

6. Display the PIN digits. (Maximum 12 digits).

The transaction details, together with the PIN, are transmitted through conventional banking communication networks to the issuing bank which has a financial transaction processing facility as shown generally in FIG. 2 by reference numeral 50. It will be appreciated that the PIN is generated in a format that is compatible with conventional financial transaction facilities such as ATM's and POS devices with no additional changes to their associated systems.

The financial transaction processing facility 50 has a front office component 52 and a back office component 54. In the front office 52 there is a processor 56, a keypad 58, a display 60 and a microphone 62 with an A/D convertor 64.

In the back office there is a processor 66, a data storage unit 68, a cryptographic key generator 70, a PIN generating application generator 72, a card type identification unit 74, a check PIN generator 76, a comparator 78, a message generator 80 and an input/output interface for connecting to the Internet 30 or a banking communication network 82.

In use, when the client desires to acquire the PIN generating application, he presents himself to a clerk at the front office 52. When the client has verified himself to the clerk the client utters the voice message which is captured by the microphone 62 and A/D converter 64 as the authenticated voice message. This authenticated voice message is stored in the data storage unit 68 in association with the client's account. The required cryptographic keys are then provided by the cryptographic key generator 72 and also stored in the data storage unit 68 in association with the client's account. These keys and the authenticated voice message are then supplied to the PIN generating application generator 72 which provides the PIN generating application which is then downloaded to the client's phone 10 via the Internet 30.

When a transaction request is received, via the communication network 82, together with a PIN that has been provided by the transactor, the relevant account is identified and a check is performed by the card type identification unit 74 to see if the supplied PIN needs to be verified. If this is the case, the appropriate cryptographic keys are supplied to the check PIN generator 76. The check PIN generator 76 then generates a check PIN using a similar algorithm to that described above and the check PIN and the supplied PIN are compared by the comparator 78. If they are the same then an approval message is provided by the message generator 80 and transmitted to the acquiring bank. Clearly, if there is no match then a rejection message is generated and transmitted.

The invention described above allows biometric verification to take place on a mobile phone, or the like, in an off-line manner and for this verification result to be represented in the form of a PIN which can then be entered in any ATM or POS device.

This invention has the advantage that PIN numbers are more secure as these vary with every transaction effected.

It will be appreciated that this invention intrinsically links biometric verification to the variable PIN thus providing biometric verification at any ATM or POS device not fitted with biometric capturing technology.

1. A financial transaction facilitating device for facilitating a financial transaction comprising:
an electronic processing device;
a data storage unit;
an input device operable by a transactor for inputting a request for a PIN;
a biometric identifier input device for inputting a biometric identifier of the transactor;
a verifying unit for verifying a biometric identifier provided, in use, by the transactor;
a PIN generator for generating a PIN if the inputted biometric identifier is verified;
and an output device for supplying the PIN to the transactor.

2. The financial transaction facilitating device of claim 1, wherein the biometric identifier is selected from the group consisting of a sound signal, a visual signal, and a fingerprint.

3. The financial transaction facilitating device of claim 1, wherein the biometric identifier is a sound signal, and wherein the biometric identifier input device comprises a microphone.

4. The financial transaction facilitating device of claim 3, wherein the sound signal is a voice message comprising a pass phrase or free speech.

5. The financial transaction facilitating device of claim 1, wherein the biometric identifier is a visual signal, and wherein the biometric identifier input device comprises a camera.

6. The financial transaction facilitating device of claim 5, wherein the visual signal is a representation of the transactor.

7. The financial transaction facilitating device of claim 1, wherein the biometric identifier is a fingerprint, and wherein the biometric identifier input device comprises a fingerprint scanner.

8. The financial transaction facilitating device of claim 1, wherein the PIN generator utilises a predetermined algorithm.

9. The financial transaction facilitating device of claim 8, wherein the algorithm is a cryptographic algorithm which uses predetermined cryptographic keys.

10. The financial transaction facilitating device of claim 8, wherein the PIN generator generates a new PIN each time a PIN is requested.

11. The financial transaction facilitating device of claim 8, wherein the PIN generator generates PINs in a sequential manner.

12. The financial transaction facilitating device of claim 1, wherein the output device is a display.

13. The financial transaction facilitating device of claim 1, wherein the device is operable in an off-line manner.

14. The financial transaction facilitating device of claim 1, further comprising a communication module for communication with a financial institution.

15. The financial transaction facilitating device of claim 1, wherein the financial transaction facilitating device is selected from the group consisting of a mobile telephone, a tablet, a portable computer, and a desktop computer.

16. A method of facilitating a financial transaction which comprises
a transactor inputting a request for a PIN to an electronic device of the transactor;
inputting a biometric identifier of the transactor;
verifying the inputted biometric identifier;
generating a PIN if the inputted biometric identifier is verified and
supplying the PIN to the transactor.

17. The method of claim 16, wherein the biometric identifier is selected from the group consisting of a sound signal, a visual signal, and a fingerprint.

18. The method of claim 16, wherein the biometric identifier is a sound signal, and wherein the biometric identifier input device comprises a microphone.

19. The method of claim 18, wherein the sound signal is a voice message comprising a pass phrase or free speech.

20. The method of claim 16, wherein the biometric identifier is a visual signal, and wherein the biometric identifier input device comprises a camera.

21. The method of claim 20, wherein the visual signal is a representation of the transactor.

22. The method of claim 16, wherein the biometric identifier is a fingerprint, and wherein the biometric identifier input device comprises a fingerprint scanner.

23. The method of claim 16, wherein a new PIN is generated each time a PIN is requested.

24. The method of claim 16, wherein the PINs are generated in a sequential manner.

25. A financial transaction processing facility of an issuer of credit or debit cards, which comprises
a receiving unit for receiving a transaction request from a transactor to whom a credit or debit card has been issued together with a PIN;
a verifying unit for verifying the PIN; and
a transaction approving unit for approving the transaction if the PIN is verified.

26. The financial transaction processing facility of claim 25, further comprising an identifying module for identifying that the transaction request is associated with a biometrically verifiable card and that the supplied PIN needs to be appropriately verified.

27. The financial transaction processing facility of claim 25, further comprising a check PIN generator for generating a check PIN and a comparator for comparing the check PIN and the received PIN.

28. The financial transaction processing facility of claim 27, wherein the check PIN generator utilises a predetermined algorithm that is the same, or complementary to, an algorithm used by a financial transaction facilitating device.

29. The processing facility of claim 28, wherein the algorithm uses cryptographic keys associated with the relevant account of the transactor.

30. A method of processing a financial transaction, which comprises
an issuer of a credit or debit card receiving a transaction request together with a PIN, from a transactor to whom the card has been issued;
verifying the received PIN; and
approving the transaction if the PIN is verified.

31. The method of claim 30, wherein the received PIN is verified by generating a check PIN and comparing it with the received PIN.
